(19) United States
(12) Patent Application Publication
(10) Pub. No.: US 2024/0120689 A1
(43) Pub. Date: Apr. 11, 2024

(54) RECEPTACLE CONNECTOR AND METHOD OF LEAK TESTING COMPONENT USING RECEPTACLE CONNECTOR

(71) Applicant: Caterpillar Inc., Peoria, IL (US)

(72) Inventors: John Ryan Jones, East Peoria, IL (US); Rodney Lee Rolffs, East Peoria, IL (US); Timothy Vincent Connor, Peoria, IL (US)

(73) Assignee: Caterpillar Inc., Peoria, IL (US)

(21) Appl. No.: 17/938,390

(22) Filed: Oct. 6, 2022

(51) Int. Cl. H01R 13/66; G01M 3/26; H01R 13/00

(52) U.S. Cl. CPC H01R 13/6683; G01M 3/26; H01R 13/005

(57) ABSTRACT

The electrical connector unit includes a first connector electrically coupled to a component to define a path for electrical supply therethrough for an activation and a deactivation of the component. The first connector includes a body, electrical contacts, and an opening. The body includes a surface that defines an array of electrical contact locations including one or more first electrical contact locations and a second electrical contact location. The electrical contacts extend correspondingly from the first electrical contact locations. The opening extends from the second electrical contact location to fluidly couple with an interior of an enclosure encasing the component. The first connector is configured to receive a second connector configured to facilitate passage of a fluid through the opening to create a pressure differential between the interior of the enclosure and an exterior of the enclosure for performing a leak testing of the enclosure.

### TECHNICAL FIELD

The present disclosure relates to electrical connectors associated with a component, and more particularly, to a receptacle connector which can be used to perform a leak testing or a pressure decay testing of an enclosure that houses the component.

### BACKGROUND

Engines and/or machines, such as compactors, pavers, haul trucks, dozers, motor graders, excavators, wheel loaders, and other types of equipment are known for performing a variety of construction or earth moving tasks. Such machines are generally equipped with various components, i.e., electrical and/or electronic components such as electronic control units, sensors, electrically or electronically controlled valve units, and the like. Such components are typically encased or housed within an enclosure that may isolate and protect the component from moisture found in the ambient environment. A leakage or ingression of moisture into the enclosure may lead to malfunctioning or a failure of the component encased within the sealed housing.

U.S. Pat. No. 10,481,038 discloses a tightness testing device for testing a wiring network formed of a charging socket, a sealed plug connector, and a cable connecting the charging socket and the sealed plug connector. The tightness testing device includes a test adapter, a fluid supply, and a measuring device. The test adapter contacts the plug connector to establish a fluid-tight connection therebetween. The fluid supply is set up so as to provide a fluid to the test adapter. The measuring device is located between the fluid supply and the test adapter. The fluid provided by the fluid supply is guided via the measuring device to the test adapter. The measuring device is set up so as to determine the tightness of the charging socket.

### SUMMARY OF THE INVENTION

In an aspect, the present disclosure relates to an electrical connector unit. The electrical connector unit includes a first connector configured to be electrically coupled to a component to define a path for electrical supply therethrough for at least one of an activation and a deactivation of the component. The first connector includes a body, one or more electrical contacts, and an opening. The body includes a surface that defines an array of electrical contact locations. The array includes one or more first electrical contact locations and a second electrical contact location. The one or more electrical contacts extends correspondingly from the one or more first electrical contact locations. The opening extends from the second electrical contact location to fluidly couple with an interior of an enclosure encasing the component. The first connector is configured to receive a second connector configured to facilitate passage of a fluid through the opening to create a pressure differential between the interior of the enclosure and an exterior of the enclosure for performing a leak testing of the enclosure.

In another aspect, the present disclosure is directed to a machine. The machine includes one or more devices and an electrical connector unit. Each device of the one or more devices is configured to perform one or more tasks associated with an operation of the machine. Each device includes a component and an enclosure encasing the component. The electrical connector unit includes a first connector configured to be electrically coupled to the component to define a path for electrical supply therethrough for at least one of an activation and a deactivation of the component. The first connector includes a body, one or more electrical contacts, and an opening. The body includes a surface that defines an array of electrical contact locations. The array includes one or more first electrical contact locations and a second electrical contact location. The one or more electrical contacts extends correspondingly from the one or more first electrical contact locations. The opening extends from the second electrical contact location to fluidly couple with an interior of the enclosure encasing the component. The first connector is configured to receive a second connector configured to facilitate passage of a fluid through the opening to create a pressure differential between the interior of the enclosure and an exterior of the enclosure for performing a leak testing of the enclosure.

In yet another aspect, the present disclosure relates to a method for a leak testing. The method includes providing a first connector of an electrical connector unit. The first connector is electrically couplable to a component to define a path for electrical supply therethrough for at least one of an activation and deactivation of the component. The first connector includes a body, one or more electrical contacts, and an opening. The body includes a surface that defines an array of electrical contact locations. The array includes one or more first electrical contact locations and a second electrical contact location. The one or more electrical contacts extends correspondingly from the one or more first electrical contact locations. The opening extends from the second electrical contact location to fluidly couple with an interior of the enclosure encasing the component. Further, the method includes joining a second connector to the first connector to facilitate passage of a fluid through the opening to create a pressure differential between the interior of the enclosure and an exterior of the enclosure for performing a leak testing of the enclosure.

### BRIEF DESCRIPTION OF DRAWINGS

FIG. 1 illustrates an exemplary machine having a device for performing a task associated with an operation of the machine, in accordance with an embodiment of the present disclosure;

FIG. 2 illustrates an electrical connector unit mounted to an enclosure of the device, in accordance with an embodiment of the present disclosure;

FIG. 3 illustrates a receptacle connector and a plug connector of the electrical connector unit, in accordance with an embodiment of the present disclosure;

FIG. 4 is a cross-sectional view of FIG. 3 along line 4-4, in accordance with an embodiment of the present disclosure;

FIG. 5 illustrates the plug connector joined to the receptacle connector, or vice versa, to perform leak testing of the enclosure, in accordance with another embodiment of the present disclosure;

FIG. 6 illustrates an electrical connector unit, in accordance with another embodiment of the present disclosure;

FIG. 7 illustrates an electrical connector unit, in accordance with yet another embodiment of the present disclosure; and

FIG. 8 depicts a flowchart illustrating a method of leak testing, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

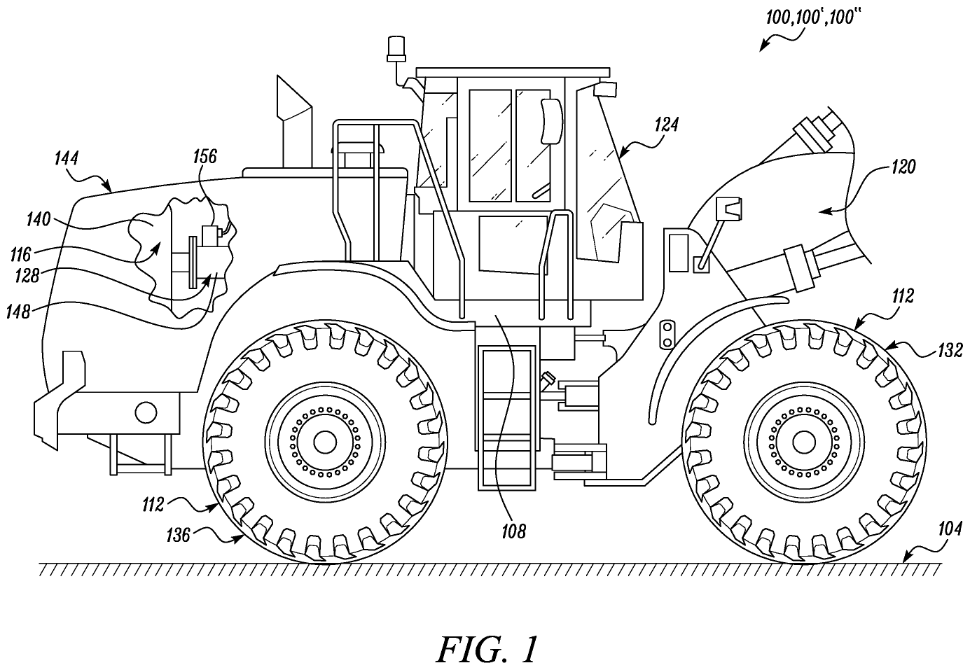

Referring to FIG. 1, an exemplary machine 100 (hereinafter referred to as “machine 100”) is shown. The machine 100 may embody a mobile machine 100′ configured to perform one or more operations associated with an industry such as mining, quarrying, construction, landscaping, farming or agriculture, forestry, transportation, or any other industry known in the art. As an example, the machine 100 is embodied as a wheel loader 100″ configured to dig and move material from a dig or loading location to a dump location at a worksite 104. Alternatively, the machine 100 may be embodied as pavers, compactors, dump trucks, loaders, excavators, cold planers, dozers, mulchers, feller bunchers, backhoe loaders, skid-steer loaders, locomotives, and the like. In other embodiments, the machine 100 may be a stationary machine, such as a generator set.

The machine 100 may include a frame 108, ground-engaging members 112, propulsion system 116, an implement 120, an operator cabin 124, and one or more devices 128. The frame 108 may accommodate and/or support the propulsion system 116, the implement 120, the operator cabin 124, and the devices 128, although other known systems may be supported by the frame 108, as well. The ground-engaging members 112 may support and propel the frame 108 (or the machine 100), for example, from one location to another location of the worksite 104. The ground-engaging members 112 may include a set of front wheels 132 and a set of rear wheels 136 (due to the orientation of the view, only one front wheel 132 and only one rear wheel 136 are shown in FIG. 1). In some embodiments, the ground-engaging members 112 may include crawler tracks (not shown) provided either alone or in combination with the wheels 132, 136.

The propulsion system 116 may include a power source 140. The power source 140 may be housed within a power compartment 144 of the machine 100. The power source 140 may include a combustion engine, an electrical power source, or a combination of both. The power source 140 may be configured to generate an output power required to operate various systems or assemblies, such as the implement 120 of the machine 100. In the present embodiment, the implement 120 is embodied as a bucket (not shown) configured to be powered (directly or indirectly) by the power source 140 to perform various operations, such as loading, hauling, and unloading, of the machine 100.

The operator cabin 124 may acquire a position between the implement 120 and the power compartment 144. The operator cabin 124 may facilitate stationing of one or more operators therein, to monitor the operations of the machine 100. Also, the operator cabin 124 may house various controls of the machine 100, access to one or more of which may help the operator(s) to control the machine's movement and/or operations. For example, the various controls of the machine 100 may include one or more steering wheels, joysticks, switches etc., to enable an operator to operate the machine 100.

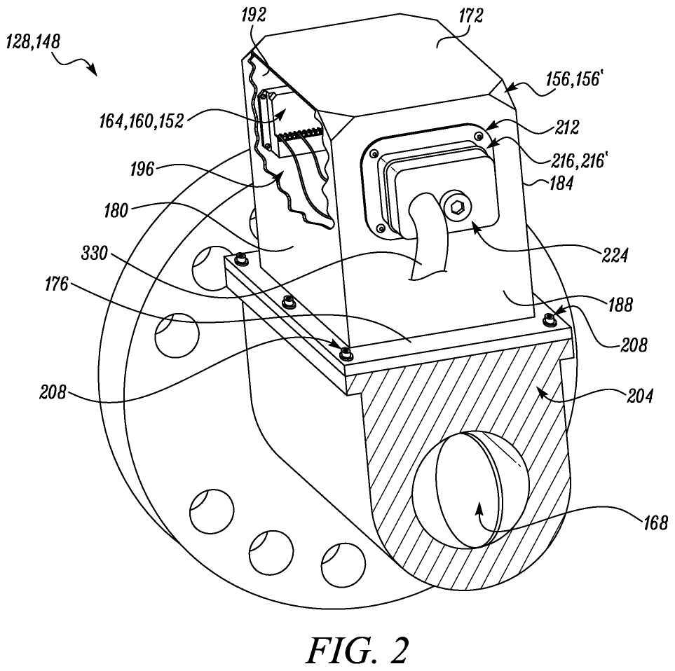

Each device 128 is configured to perform one or more tasks associated with the operation of the machine 100. One such device 128, for example, is a metering valve unit 148 (as shown in FIGS. 1 and 2). The metering valve unit 148 may be fluidly coupled to the power source 140 of the machine 100. The metering valve unit 148 may be configured to supply a controlled amount of combustion mixture (e.g., air-fuel mixture) to the power source 140 of the machine 100.

The device 128 (or the metering valve unit 148) includes one or more components 152 and an enclosure 156. The components 152 may include at least one electrical (or electronic) component 160 that may operate (e.g., activate or deactivate) in order to facilitate the device 128 (or the metering valve unit 148) to perform the tasks associated with the operation of the machine 100. In an exemplary embodiment, as shown in FIG. 2, the electrical (or electronic) component 160 includes a valve controller 164 configured to control a degree of opening and/or closing of a valve element 168 of the metering valve unit 148 for supplying the controlled amount of the combustion mixture to the power source 140. In other embodiments, the electrical (or electronic) component 160 may embody as pressure sensors, temperature sensors, mass-flow rate sensors, and actuating solenoids, or any other electrical (or electronic) component already or hereafter known in the art.

The enclosure 156 encases the component 152 (e.g., the valve controller 164) in a manner to isolate and/or protect the component 152 from outside environmental factors, such as moisture, dust, and the like. By way of non-limiting example, enclosure 156 may be embodied as a substantially cuboid shaped structure 156′ that defines a top plate 172, a bottom plate 176, a first side plate 180, a second side plate 184, a first face plate 188, and a second face plate 192. The top plate 172 and the bottom plate 176 are disposed parallel to and spaced apart from each other. Each of the first side plate 180 and the second side plate 184 is disposed perpendicular to the top plate 172 and the bottom plate 176. Also, the first side plate 180 and the second side plate 184 are disposed parallel to and spaced apart from each other. Each of the first face plate 188 and the second face plate 192 is disposed perpendicular to the top plate 172, the bottom plate 176, the first side plate 180, and the second side plate 184. In addition, the first face plate 188 and the second face plate 192 are disposed parallel to and spaced apart from each other. The top plate 172, the bottom plate 176, the first side plate 180, the second side plate 184, the first face plate 188, and the second face plate 192 may be coupled (e.g., welded) to each other to define an interior 196 for encasing the component 152 (e.g., the valve controller 164).

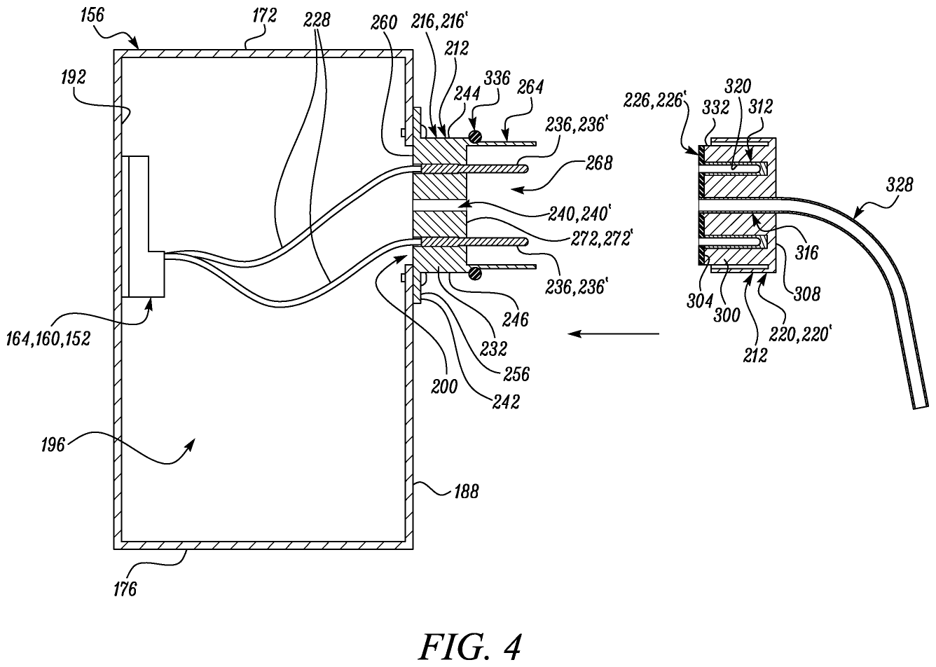

Further, the enclosure 156 is provided with an aperture 200 (as shown in FIG. 4). In an exemplary embodiment, the aperture 200 is defined at the first face plate 188 of the enclosure 156. However, it should be noted that the aperture 200 may be defined at any suitable location on the enclosure 156. The enclosure 156 (encasing the component 152) may be mounted at any suitable location on or in vicinity of the device 128 (or the metering valve unit 148). In an exemplary embodiment, as shown in FIG. 2, the enclosure 156 is mounted to a valve housing 204 of the metering valve unit 148 in a manner such that the bottom plate 176 is coupled to the valve housing 204 of the metering valve unit 148, e.g., via fasteners 208.

It should be noted that the machine 100 may include other devices (of the one or more devices 128), each having one or more components (similar to the component 152) encased within their corresponding enclosures (similar to the enclosure 156). Such other devices may include display devices, exhaust treatment devices, navigation devices, actuating devices, heating ventilation air conditioning (HVAC) devices, or any other devices already known in the art. However, such other devices are not discussed herein, for the sake of brevity. As shown in FIG. 2, a portion of valve housing 204 is shown in cross-section so that valve element 168 can be seen.

In order to operate (e.g., activate or deactivate), the component 152 (encased within the enclosure 156) may be required to be in electrical communication with, for example, an electrical power supply source (not shown) or an ECU (electronic control unit) (not shown) of the machine 100. Also, the component 152 may be susceptible to failure due to infiltration of moisture (or any other foreign matter) in the interior 196 through a leak path (e.g., a gap or a crack) that may be formed on the enclosure 156 or at the junction where enclosure 156 is joined to the valve housing 204. Therefore, leak testing of the enclosure 156 encasing the component 152 is required to be performed during manufacturing, and possibly during later use, at regular and/or irregular intervals.

To electrically connect the component 152 with, for example, the electrical power supply source (or the ECU), and/or to facilitate the leak testing of the enclosure 156, in one or more aspects of the present disclosure, an electrical connector unit 212 is disclosed. The electrical connector unit 212 provides an electrical interface between the component 152 and the electrical power supply source (or the ECU) of the machine 100. Also, the electrical connector unit 212 allows the manufacturer and/or the operator to perform the leak testing of the enclosure 156 (encasing the component 152). The electrical connector unit 212 includes a first connector 216. In addition, the electrical connector unit 212 may include a second connector 220, a third connector 224, and a seal 226.

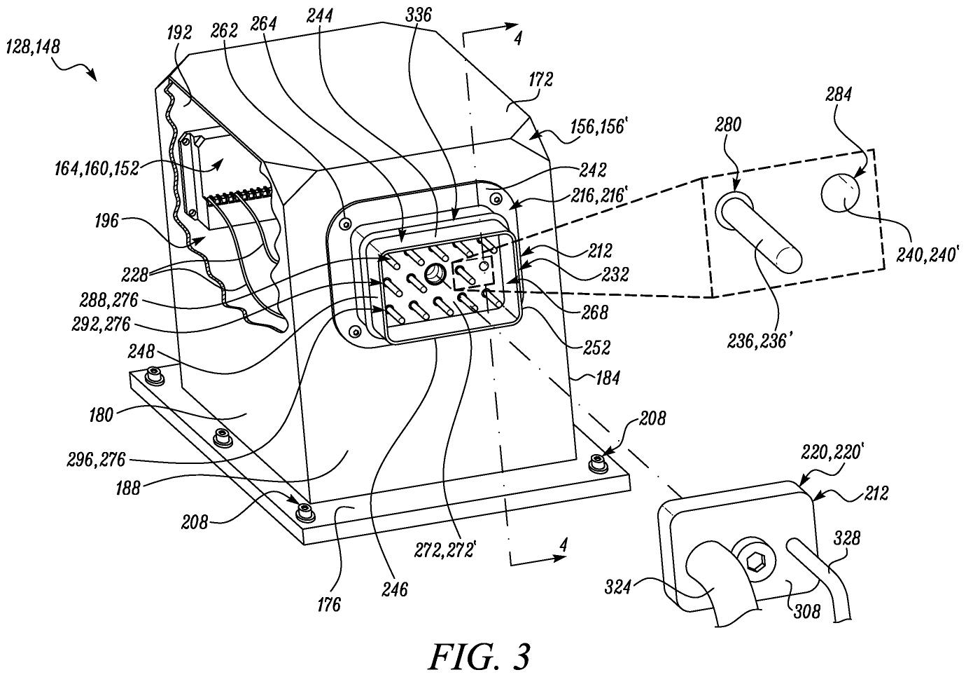

The first connector 216 is now discussed. The first connector 216 is configured to be electrically coupled to the component 152 to define a path for electrical supply (e.g., from the electric power supply source, the ECU, etc.) therethrough for the activation or the deactivation of the component 152. For example, as shown in FIG. 3, the first connector 216 is electrically coupled to the component 152, via one or more electrical wires 228 extending between the first connector 216 and the component 152. Alternatively, the component 152 could be mounted directly to the first connector 216, reducing or even eliminating the need for wiring. In the present embodiment, the first connector 216 is a receptacle connector 216′.

Referring to FIGS. 3 and 4, the first connector 216 includes a body 232, one or more electrical contacts 236, and an opening 240. The body 232 may define a flanged wall portion 242, a top wall portion 244, a bottom wall portion 246, a first side wall portion 248, and a second side wall portion 252. The flanged wall portion 242 may define a first end surface 256 and a second end surface 260 opposite to the first end surface 256 (as shown in FIG. 4). The flanged wall portion 242 may be configured to abut against at least one plate of the enclosure 156 for mounting the first connector 216 to the enclosure 156. In an exemplary embodiment, as shown in FIG. 4, the second end surface 260 of the flanged wall portion 242 abuts against the first face plate 188 of the enclosure 156 and is fastened (e.g., via fasteners 262) to the first face plate 188 to mount the first connector 216 to the enclosure 156. Further, the flanged wall portion 242 may abut against the first face plate 188 in a manner to completely cover the aperture 200 formed on the first face plate 188 (see FIG. 4). In this configuration, the electrical wires 228 extending out from the first connector 216 may pass through the aperture 200 to electrically connect with the component 152.

The top wall portion 244 and the bottom wall portion 246 are disposed parallel to and spaced apart from each other. The first side wall portion 248 and the second side wall portion 252 are disposed perpendicular to the top wall portion 244 and the bottom wall portion 246. Also, the first side wall portion 248 and the second side wall portion 252 are disposed parallel to and spaced apart from each other. The top wall portion 244, the bottom wall portion 246, the first side wall portion 248, and the second side wall portion 252 may extend outwardly away from the flanged wall portion 242 to define an outer periphery 264 of the body 232. Also, the top wall portion 244, the bottom wall portion 246, the first side wall portion 248, and the second side wall portion 252 may combinedly define an inner cavity 268.

Further, the body includes a surface 272. In the present embodiment, the surface 272 defines an interior end wall 272′ of the inner cavity 268. The surface 272 defines an array of electrical contact locations 276. The array 276 includes one or more first electrical contact locations 280 and a second electrical contact location 284. The first electrical contact locations 280 and the second electrical contact location 284 may be defined in a spaced apart arrangement. In an exemplary embodiment, as shown in FIG. 3, the first electrical contact locations 280 and the second electrical contact location 284 are arranged in three rows—a first row 288 having five first electrical contact locations 280, a second row 292 having three first electrical contact locations 280 and one second electrical contact location 284, and a third row 296 having five first electrical contact locations 280. It should be noted that, in other embodiments, the first electrical contact locations 280 and the second electrical contact location 284 may be arranged in any suitable number of rows, or even in irregular patterns. Additionally, more than one second electrical contact location 284 may be provided.

In addition, the first electrical contact locations 280 and the second electrical contact location 284 may be arranged in a staggered pattern on the surface 272. When arranged in the staggered pattern, any of the first electrical contact locations 280 of the first row 288 do not align with any of the first electrical contact locations 280 or the second electrical contact location 284 of the second row 292, and similarly, any of the first electrical contact locations 280 or the second electrical contact location 284 of the second row 292 do not align with any of the first electrical contact locations 280 of the third row 296. In the present embodiment, the second electrical contact location 284 is proximal to the second side wall portion 252 and distal to the first side wall portion 248.

The electrical contacts 236 may include conductive pins 236′, at least some of which are electrically coupled to the one or more electrical wires 228 (as shown in FIG. 4) to allow the electric supply (or electrical signals) to pass therethrough, for example, for the activation or the deactivation of the component 152. The electrical contacts 236 are embedded within the body 232 of the first connector 216. The electrical contacts 236 extend out from their corresponding first electrical contact locations 280 defined on the surface 272. Accordingly, the electrical contacts 236 may be arranged in the staggered pattern.

The opening 240 is a through-hole 240′ that extends from the second electrical contact location 284 defined on the surface 272. As shown in FIG. 4, the opening 240 (or the through-hole 240′) extends inwardly from the second electrical contact location 284 to the second end surface 260 of the flanged wall portion 242 to fluidly couple with the interior 196 of the enclosure 156. The opening 240 is configured to allow fluid to pass therethrough into the interior 196 of the enclosure 156 for performing the leak testing of the enclosure 156.

The second connector 220 is now discussed. The second connector 220 may be configured to operate as a ‘test connector’ for performing leak testing of the enclosure 156, using a leak testing device (not shown). In the present embodiment, the second connector 220 is a plug connector 220′ configured to establish the electrical connection as well as the fluid connection between the first connector 216 and the leak testing device for performing the leak testing of the enclosure 156. If desired, electrical testing using the second connector 220 also could be performed, possibly at the same time as the leak testing.

Referring to FIG. 4, the second connector 220 includes a body 300 that may define a first end surface 304 and a second end surface 308 opposite to the first end surface 304. The body 300 includes one or more receptacles 312 and a through-passage 316. The receptacles 312 may be configured to correspondingly receive the electrical contacts 236 of the first connector 216, when the second connector 220 is joined to (or received by) the first connector 216. Each receptacle 312 may include electrically conducting walls 320 that are electrically connected to a power or signal supply line 324 (shown in FIG. 3) extended, for example, from the leak testing device. The electrically conducting walls 320 of each receptacle 312 may be sized such that the electrical contact 236, when received within its corresponding receptacle 312, contacts the corresponding electrically conducting walls 320 to establish electrical connection between the receptacle 312 and the electrical contact 236. In the present embodiment, the second connector 220 includes the same number of receptacles 312 as the number of electrical contacts 236 provided on the first connector 216.

The through-passage 316 extends between the first end surface 304 and the second end surface 308 of the body 300. The through-passage 316 is configured to receive (or couple with) a fluid supply line 328 extended, for example, from the leak testing device. In an example, the through-passage 316 may define an internal threaded wall, and an outlet end portion of the fluid supply line 328 may be threadably engaged with the internal threaded wall of the through-passage 316. Further, the through-passage 316 is positioned in the second connector 220 to align with the opening 240 of the first connector 216, when the second connector 220 is joined to (or received by) the first connector 216.

Once the fluid supply line 328 is coupled to the through-passage 316, and the second connector 220 is joined to (or received by) the first connector 216, the through-passage 316 establishes a fluid connection between the fluid supply line 328 (e.g., from the leak testing device) and the opening 240 provided in the first connector 216. Accordingly, the second connector 220 facilitates passage of a fluid (supplied from the leak testing device via the fluid supply line 328) through the opening 240 to create a pressure differential between the interior 196 of the enclosure 156 and an exterior of the enclosure 156 for performing the leak testing of the enclosure 156.

The third connector 224, as shown in FIG. 2, is now discussed. The third connector 224 may be similar in many respects to the second connector 220 but may differ from the second connector 220 in that the through-passage 316 (provided in the second connector 220) is altogether omitted from the third connector 224. Accordingly, the third connector 224 may be configured to operate as a ‘in-field connector’ for providing the electrical supply, for example, via an electric supply line 330 from the ECU of the machine 100, to the component 152 upon mating with the first connector 216.

Referring to FIG. 4, the seal 226 is now discussed. The seal 226 may be provided on at least one of the first connector 216 and the second connector 220. In the present embodiment, the seal 226 is a face seal 226′ arranged within a channel 332 provided on the second connector 220. For instance, the face seal 226′ is placed (or bonded) on the first end surface 304 of the second connector 220. The seal 226 may be configured to define a sealed connection between the first connector 216 and the second connector 220 (or the third connector 224), when the first connector 216 is mated with the second connector 220 (or the third connector 224). In addition to the seal 226, another seal, in the form of an O-ring seal 336, may be provided on the outer periphery 264 of the first connector 216 to further establish the sealed connection between the first connector 216 and the second connector 220 (or the third connector 224). In some examples, seal 226 could be omitted and O-ring seal 336 alone would serve to maintain a pressure differential between the interior 196 of the enclosure 156 and the external environment.

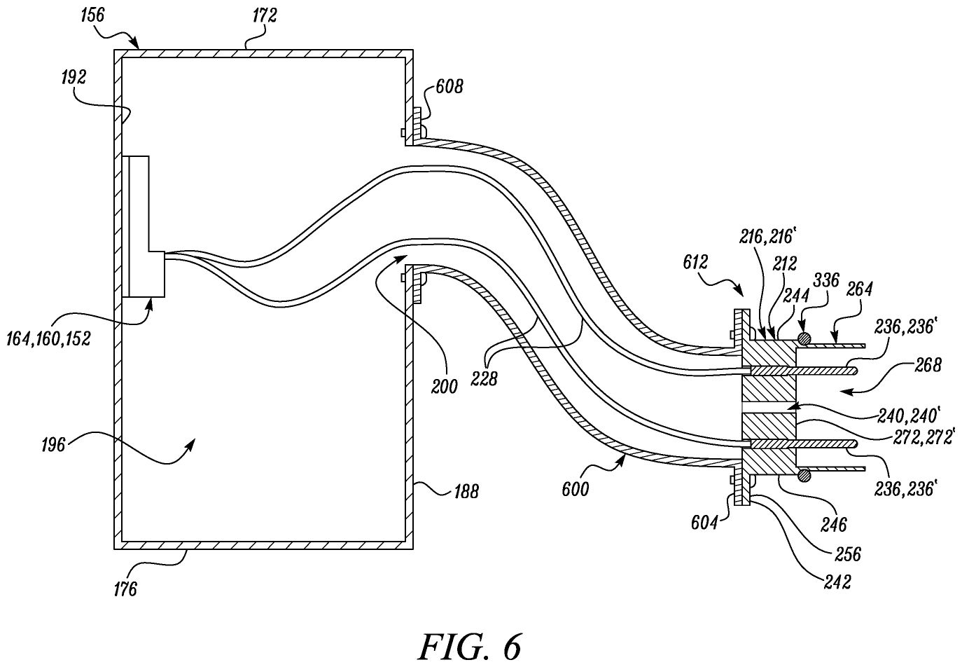

Referring to FIG. 6, an electrical connector unit 612 is shown. The electrical connector unit 612 may be similar in all respects to the electrical connector unit 212 but may differ from the electrical connector unit 212 in that the electrical connector unit 612 includes a conduit 600. The conduit 600 may include a first end portion 604 and a second end portion 608. The conduit 600 may extend between the first connector 216 and the enclosure 156 such that the first end portion 604 (of the conduit 600) is coupled to the flanged wall portion 242 of the first connector 216 and the second end portion 608 (of the conduit 600) is coupled to the first face plate 188 of the enclosure 156 in a manner to cover the aperture 200 provided on the enclosure 156. The conduit 600 may be configured to fluidly couple the opening 240 provided on the first connector 216 with the interior 196 of the enclosure 156. In addition, the conduit 600 may be configured to allow the electrical wires 228 extending out from the first connector 216 to pass therethrough and the aperture 200 to electrically connect the first connector 216 with the component 152.

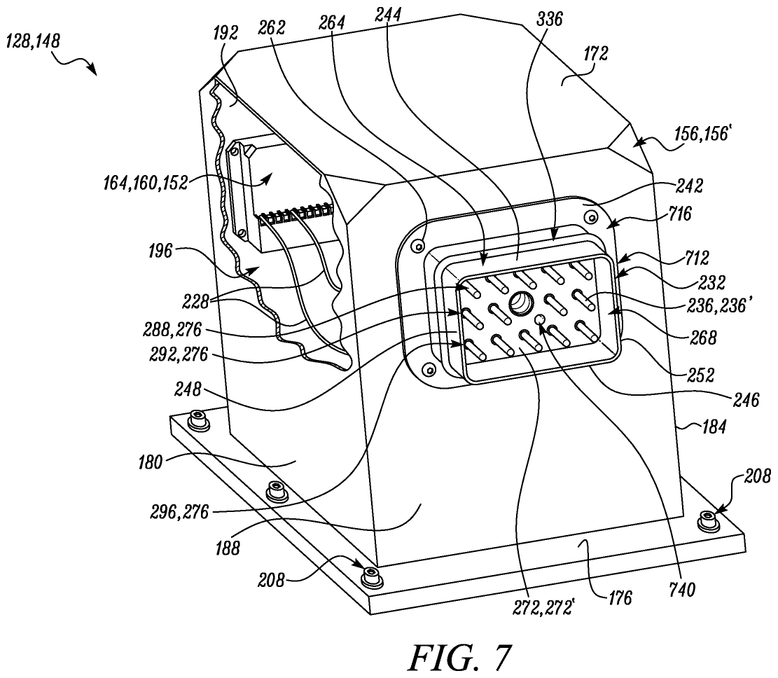

Referring to FIG. 7, an electrical connector unit 712 is shown. The electrical connector unit 712 may be similar in all respects to the electrical connector unit 212 but may differ from the electrical connector unit 212 in that the electrical connector unit 712 includes a first connector 716 having a different opening 740. The first connector 716 and the different opening 740 may have constructions and configurations similar to the first connector 216 and the opening 240, respectively. The different opening 740 may be located at a different location on the surface 272 than the opening 240 shown in FIG. 3. The different location may be defined as a location (on the surface 272) that, while part of the regular array of electrical contact locations 276 defined at the surface 272, is not located at one of the regular array of electrical contact locations 276 (in other words, it is not at a regular array position). In the present embodiment, as shown in FIG. 7, the first connector 716 is provided only with the different opening 740. In such a case, the through-passage 316 provided on the corresponding second connector 220 may be located at a position to align with the different opening 740 for establishing a fluid connection between the fluid supply line 328 (e.g., from the leak testing device) and the different opening 740. However, in other embodiments, the first connector 716 may simultaneously include both the different opening 740 and the opening 240.

### INDUSTRIAL APPLICABILITY

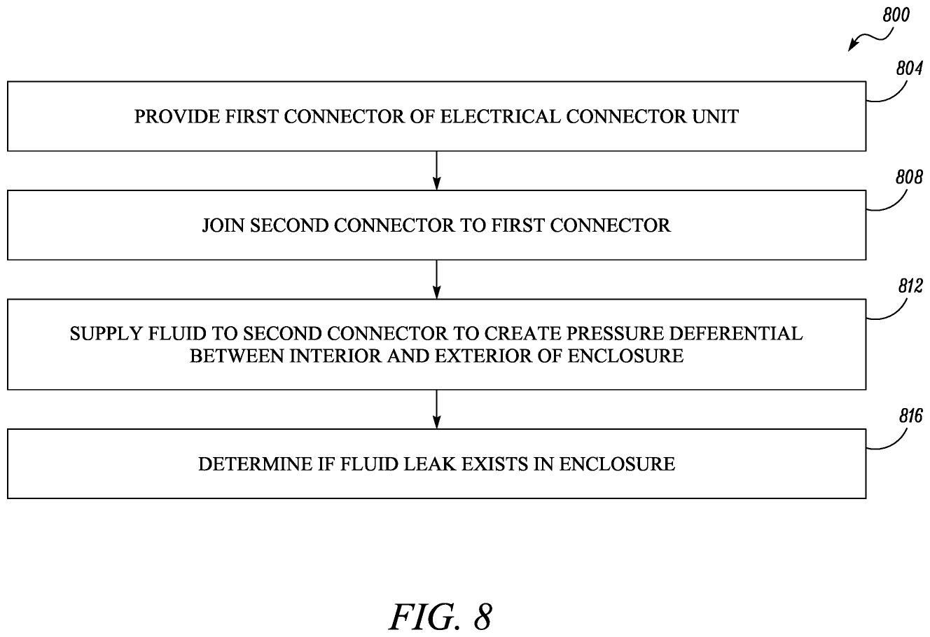

Referring to FIG. 8, an exemplary method for leak testing an enclosure (such as the enclosure 156 encasing the component 152), using the electrical connector unit 212, 612, 712, is discussed. The method is discussed by way of a flowchart 800 that illustrates exemplary steps (i.e., from 804 to 816) associated with the method. The method is also discussed in conjunction with FIGS. 1-7.

Components, such as the component 152, may operate (e.g., activate or deactivate) upon receiving the electrical supply, for example, from the electrical power source supply (or the ECU) of the machine 100. Also, such components are susceptible to premature failure upon contact with moisture, or dust. To isolate and/or protect the components from the moisture, or dust, such components are encased within the enclosure 156, such as within the interior 196 of the enclosure 156. However, during manufacturing and/or field usage of the enclosure 156, one or more leaks (e.g., gaps, cracks, etc.) may be formed on the enclosure 156.

To electrically connect the component 152 and/or to determine if any leak is formed on the enclosure 156, the first connector 216, 716, is provided (STEP 804). The first connector 216 may be mounted either directly to the first face plate 188 of the enclosure 156 (as shown in and discussed with reference to FIGS. 2-5 and 7) or via the conduit 600 extending between the first connector 216, 716 and the enclosure 156 (as shown in and discussed with reference to FIG. 6). In both the cases, the opening 240 (or the different opening 740) provided on the first connector 216, 716 is fluidly coupled with the interior 196 of the enclosure 156.

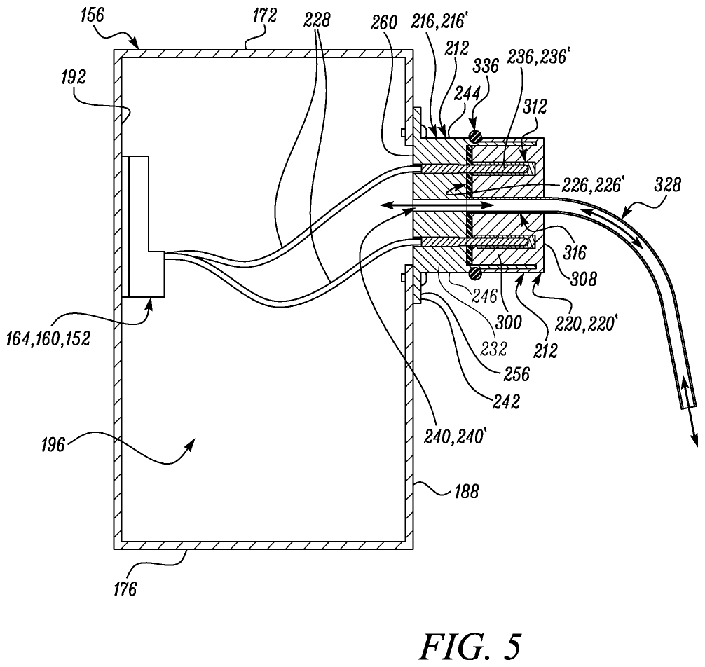

To determine whether a fluid leak exists in the enclosure 156, the second connector 220 is joined to the first connector 216, 716 (STEP 808) (as shown in FIGS. 4 and 5). For that, the second connector 220 is received by the first connector 216, 716 in a manner such that: the electrical contacts 236 of the first connector 216, 716 are received within their corresponding receptacles 312 provided on the second connector 220; the seal 226 is abutted against the surface 272 of the first connector 216, 716; and the through-passage 316 (along with the fluid supply line 328 from the leak testing device) of the second connector 220 is aligned with the opening 240 (or the different opening 740) of the first connector 216, 716 to establish the fluid connection between the fluid supply line 328 and the opening 240 (or the different opening 740). Once the second connector 220 is received by the first connector 216, 716, the second connector 220 is joined to the first connector 216, 716, for example, via a fastening mechanism (not shown).

Once the second connector 220 is joined to the first connector 216, 716, fluid (e.g., gas or air) is supplied to the second connector 220 to create the pressure differential between the interior 196 of the enclosure 156 and the exterior of the enclosure 156 (STEP 812). In one embodiment, fluid may be supplied to the second connector 220, from the leak testing device via fluid supply line 328, to introduce a positive pressure in the interior 196 of the enclosure 156. In another embodiment, fluid may be supplied to the second connector 220, from the interior 196 of the enclosure 156 via the opening 240 (or the different opening 740), to introduce a negative pressure (or vacuum) in the interior 196 of the enclosure 156. The pressure differential between the interior 196 of the enclosure 156 and the exterior of the enclosure 156 is created to achieve a predetermined set pressure in the interior 196 of the enclosure 156.

Once the predetermined set pressure in the interior 196 of the enclosure 156 is achieved, introduction of the positive pressure or the negative pressure in the interior 196 of the enclosure 156 is stopped. Subsequently, any change in pressure (in the interior 196 of the enclosure 156) over a predetermined time is monitored (e.g., via the leak testing device) to determine whether the fluid leak exists in the enclosure 156 (STEP 816). For example, if the change in pressure within the predetermined time exceeds a predetermined threshold value, that change of pressure is indicative of a leak in the enclosure 156. Alternatively, a leak could be diagnosed by a visual indication of fluid leaking into or from the enclosure.

The electrical connector unit 212, 612, 712, may be applicable to any work machine (such as the machine 100) that includes at least one component (such as the component 152) encased within an enclosure (such as the enclosure 156). The electrical connector unit 212, 612, 712 eliminates a need of forming an extra inlet port (or a hole) on the enclosure 156 for performing the leak testing of the enclosure 156. Eliminating the extra inlet port (or the hole) on the enclosure 156 may mitigate a risk of forming any potential leak path for the moisture or dust ingression within the enclosure 156, for example, after leak testing of the enclosure 156. Accordingly, the electrical connector unit 212, 612, 712, provides a simple and cost-effective solution for providing electrical supply to the component 152 as well as performing the leak testing of the enclosure 156 encasing the component 152.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the electrical connector, the machine, and the method of the present disclosure without departing from the scope of the disclosure. Other embodiments will be apparent to those skilled in the art from consideration of the specification and practice of the electrical connector disclosed herein. It is intended that the specification and examples be considered as exemplary only, with a true scope of the disclosure being indicated by the following claims and their equivalent.

What is claimed is:

1. An electrical connector unit, comprising:
a first connector configured to be electrically coupled to a component to define a path for electrical supply therethrough for at least one of an activation and a deactivation of the component, the first connector including:
a body including a surface defining an array of electrical contact locations, the array including one or more first electrical contact locations and a second electrical contact location;
one or more electrical contacts extending correspondingly from the one or more first electrical contact locations; and
an opening extending from the second electrical contact location to fluidly couple with an interior of an enclosure encasing the component,
wherein the first connector is configured to receive a second connector configured to facilitate passage of a fluid through the opening to create a pressure differential between the interior of the enclosure and an exterior of the enclosure for performing a leak testing of the enclosure.

2. The electrical connector unit of claim 1, further comprising the second connector, and the second connector is configured to define a sealed connection with the first connector upon mating with the first connector.

3. The electrical connector unit of claim 2, wherein one of the first connector and the second connector defines a channel, and wherein the electrical connector unit further includes:
a seal arranged within the channel and configured to contact the other of the first connector and the second connector to define the sealed connection between the first connector and the second connector.

4. The electrical connector unit of claim 1, wherein the second electrical contact location is not at a regular array position.

5. The electrical connector unit of claim 1, further comprising a conduit extending between the first connector and the enclosure to fluidly couple the opening with the interior of the enclosure.

6. The electrical connector unit of claim 2, wherein the first connector is a receptacle connector.

7. The electrical connector unit of claim 2, wherein the second connector is a plug connector.

8. A machine, comprising:
one or more devices, each device of the one or more devices configured to perform one or more tasks associated with an operation of the machine, the one or more devices including:
a component;
an enclosure encasing the component; and
an electrical connector unit including:
a first connector configured to be electrically coupled to the component to define a path for electrical supply therethrough for at least one of an activation and a deactivation of the component, the first connector including:
a body including a surface defining an array of electrical contact locations, the array including one or more first electrical contact locations and a second electrical contact location;
one or more electrical contacts extending correspondingly from the one or more first electrical contact locations; and
an opening extending from the second electrical contact location to fluidly couple with an interior of the enclosure encasing the component,
wherein the first connector is configured to receive a second connector configured to facilitate passage of a fluid through the opening to create a pressure differential between the interior of the enclosure and an exterior of the enclosure for performing a leak testing of the enclosure.

9. The machine of claim 8, wherein the electrical connector unit further includes the second connector, and the second connector is configured to define a sealed connection with the first connector upon mating with the first connector.

10. The machine of claim 9, wherein one of the first connector and the second connector defines a channel, and wherein the electrical connector unit further includes:
a seal arranged within the channel and configured to contact the other of the first connector and the second connector to define the sealed connection between the first connector and the second connector.

11. The machine of claim 8, wherein the second electrical contact location is not at a regular array position.

12. The machine of claim 8, wherein the electrical connector unit further includes a conduit extending between the first connector and the enclosure to fluidly couple the opening with the interior of the enclosure.

13. The machine of claim 8, wherein the first connector is a receptacle connector.

14. The machine of claim 8, wherein the second connector is a plug connector.

15. A method for a leak testing, the method comprising:
providing a first connector of an electrical connector unit, the first connector being electrically couplable to a component to define a path for electrical supply therethrough for at least one of an activation and a deactivation of the component, the first connector including:
a body including a surface defining an array of electrical contact locations, the array including one or more first electrical contact locations and a second electrical contact location;
one or more electrical contacts extending correspondingly from the one or more first electrical contact locations; and
an opening extending from the second electrical contact location to fluidly couple with an interior of an enclosure encasing the component; and
joining a second connector to the first connector to facilitate passage of a fluid through the opening to create a pressure differential between the interior of the enclosure and an exterior of the enclosure for performing the leak testing of the enclosure.

16. The method of claim 15, further comprising supplying fluid to the second connector, thereby creating the pressure differential, and monitoring the pressure differential to determine whether a fluid leak exists.

17. The method of claim 15, the second connector is joined to the first connector to define a sealed connection between the first connector and the second connector.

18. The method of claim 17, wherein one of the first connector and the second connector defines a channel, and wherein the electrical connector unit further includes:
a seal arranged within the channel and configured to contact the other of the first connector and the second connector to define the sealed connection between the first connector and the second connector.

19. The method of claim 17, wherein the first connector is a receptacle connector.

20. The method of claim 17, wherein the second connector is a plug connector.
